(19) United States
(12) Patent Application Publication
(10) Pub. No.: US 2007/0227848 A1
(43) Pub. Date: Oct. 4, 2007

(54) Piston arrangement

(75) Inventor: Jorg Schoppet, Gensingen (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH, Koblenz (DE)

(21) Appl. No.: 11/732,354

(22) Filed: Apr. 3, 2007

(30) Foreign Application Priority Data
Apr. 4, 2006 (DE) 10 2006 015 605.6

(51) Int. Cl. F16F 9/00

(52) U.S. Cl. 188/322.22

(57) ABSTRACT

A piston arrangement which can be fitted into a cylinder having an inside wall, the arrangement including a piston and a radial damping element which damps movement of the piston arrangement, the radial damping element having at least two sector-shaped sections which are loaded radially outward against the inside wall of the cylinder.

### BACKGROUND OF THE INVENTION

1. Field of the Invention

The invention pertains to a piston arrangement, which can be introduced into a hollow cylinder and has a radial damping element, which is assigned to the piston arrangement and damps movements of the piston arrangement relative to an inside wall of the hollow cylinder.

2. Description of the Related Art

Piston arrangements are used in particular for piston-cylinder arrangements with a hollow cylinder. The piston arrangement can be connected to a rod projecting through the hollow cylinder, so that the piston arrangement can slide back and forth axially inside the cylinder by way of the piston rod. The piston arrangement can also divide the hollow cylinder of the piston-cylinder arrangement into two working spaces. The piston arrangement can be guided inside the hollow cylinder. U.S. Pat. No. 5,806,840 describes a fluid-filled cylinder-piston rod unit, which has spring tongues resting elastically against the inside wall of their housing. U.S. Pat. No. 6,199,673 describes a noiseless damper with an anti-chatter shaft. U.S. Pat. No. 4,989,700 describes a gas spring with a piston arrangement which acts to reduce chatter. U.S. Pat. No. 5,964,454 describes a piston-cylinder assembly with a piston which compensates for manufacturing tolerances.

### SUMMARY OF THE INVENTION

An object of the invention is to provide an improved and especially an alternative piston arrangement and/or piston-cylinder arrangement.

A piston arrangement according to the invention can be introduced into a hollow cylinder and has a radial damping element. The radial damping element is assigned to the rest of the piston arrangement; it can, for example, be connected to it, and damps movements of the piston arrangement relative to an inside wall of the hollow cylinder. With the help of the radial damping element, especially lateral movements such as those caused by lateral accelerations acting on the hollow cylinder, can be damped. These lateral accelerations, which can arise through a vibration of the hollow cylinder, for example, would, without such a radial damping element, cause the piston arrangement to hit the inside wall of the hollow cylinder and therefore produce undesirable noise. The radial damping element has at least two sections in the form of sectors of a circle. The sector-shaped sections are pretensioned radially against the inside wall of the hollow cylinder.

It is advantageous for the sector-shaped sections to be connected to each other by at least one spring damping element, so that, as a result, the minimum of two sector-shaped sections can be spring-loaded against the inside wall of the hollow cylinder. The radial damping element is assigned to the piston arrangement. It is advantageous for lateral movements of the piston arrangement relative to the inside wall of the hollow cylinder to be avoided or at least damped. The minimum of one spring damping element can absorb the forces which occur and/or convert the energies being released in such a way that the possible movements of the piston arrangement inside the hollow cylinder are damped. The minimum of two sector-shaped sections are supported with freedom to move relative to each other by means of at least one spring damping element and can therefore damp movements.

According to another exemplary embodiment, the minimum of one spring damping element connects the minimum of two sector-shaped sections integrally together. The integral connection can be executed in the form of, for example, a material joint. For this purpose, the material of the spring damping element can have elastic properties overall, so that a one-piece spring damping element becomes possible. Through internal friction, the spring damping element can also have damping properties, so that movements of the sector-shaped sections in the radial direction with respect to each other can be damped advantageously. The pretension provided by the spring damping element can oppose these movements. The degree of pretension should be selected so that the dynamic friction of the sector-shaped sections against the inside wall of the hollow cylinder is as low as possible and/or a desired degree of friction is reached but nevertheless the piston arrangement can be effectively prevented from striking the inside wall.

According to another exemplary embodiment, the radial damping element has three spring damping elements. The spring damping elements can extend around various angles, so that, regardless of the angle at which the lateral forces are acting, there will always be an equally good spring damping effect. The radial damping element can have three sector-shaped sections, where three sections are connected elastically to each other in pairs by three spring damping elements. Therefore, the three sector-shaped elements form three cheeks, which can be pushed away from each other by the three spring damping elements in such a way that the radial damping element can be pretensioned against the inside wall of the hollow cylinder.

Another exemplary embodiment is characterized in that each of the minimum of two sections in the form of sectors of a circle has a recess for the minimum of one spring damping element. Advantageously, the recess can hold the spring damping element in the tensioned state. It is therefore possible to bring the sector-shaped sections very tightly together against the elastic force of the spring damping elements, and in particular to bring them flush against each other, where the spring damping elements are each located in the recess in question.

According to a preferred exemplary embodiment, the radial damping element is located between a piston body and a piston disk of the piston arrangement. The radial damping element can come to rest in the axial direction against the piston body and the piston disk. As a result, an axial displacement of the radial damping element relative to the rest of the piston arrangement and/or deformations can be advantageously avoided or at least kept within limits. The sector-shaped sections of the radial damping element remain free to move in the radial direction.

Another exemplary embodiment is characterized in that the piston arrangement has a piston rod with a pin. The minimum of two sector-shaped sections are supported elastically and/or with a damping action against the pin, so that lateral relative movements of the rest of the piston arrangement assigned to the pin with respect to the hollow cylinder can be minimized and/or damped.

Another exemplary embodiment is characterized in that the pin is located at one end of the piston rod. Advantageously, the pin has a shoulder, against which the piston disk rests. Therefore, as a result of the shoulder, the axial movement of the piston disk is limited, and in particular the disk is fixed in position. Depending on the design of the shoulder, on the length of the pin, and on the shape of the piston body, the amount of play allowed for the axial guidance of the radial damping element can be adjusted. Advantageously, therefore, the sector-shaped sections are free to move in the radial direction with minimal friction. It is thus possible to prevent the sector-shaped sections of the radial damping element from becoming jammed between the piston body and the piston disk.

According to a preferred exemplary embodiment, the radial damping element has a ring element, surrounded by at least two sector-shaped sections. The ring element can advantageously be permanently connected to the rest of the piston arrangement, especially to the pin; the ring element can surround the pin with a press-fit, for example, or with a certain amount of play. The radial damping element is thus connected to the rest of the piston arrangement by way of the ring element, where the ring element is assigned to the minimum of two sector-shaped sections. Advantageously, the ring element can be connected by means of additional inner spring damping elements. For this purpose, the ring element can be connected to at least one inner spring damping element per sector-shaped section. The inner spring damping elements can connect the ring element integrally to the associated sector-shaped section; in particular, the inner damping elements can be designed as a material joint.

A preferred exemplary embodiment is characterized in that the ring element is thicker than the minimum of two sector-shaped sections of the radial damping element. Advantageously, the piston disk can come to rest against the ring and thus be limited in its freedom of movement in the axial direction; in particular, it can be fixed in position in this way. For example, it can be clamped between the rivet head of the pin and the ring. Depending on the thickness of the ring in comparison to that of the minimum of two sector-shaped sections, a certain amount of play can thus be selected, for the axial guidance of the minimum of two sector-shaped sections of the radial damping element. Advantageously, therefore, the sector-shaped sections are free to move in the radial direction with minimal friction. The sector-shaped sections can thus be prevented from becoming jammed between the piston body and the piston disk.

It is preferable to have a certain gap between the minimum of two sector-shaped sections. The inward spring travel, i.e., the spring travel of the spring damping elements, can be determined advantageously by adjusting this gap. Similarly, a ring-shaped gap can be provided between the ring element and the sector-shaped sections surrounding it.

Additional exemplary embodiments of the invention pertain to a piston-cylinder arrangement with a hollow cylinder. The piston arrangement is introduced into the hollow cylinder, and the piston arrangement divides the hollow cylinder into two working spaces. Advantageously, the radial damping element of the piston arrangement transmits and/or damps any lateral forces and/or accelerations which may occur to the piston arrangement in such a way that the tendency to chatter is avoided or can at least be reduced to a minimum. The hollow cylinder can contain a pressurized gas, so that a gas spring with minimal tendency to chatter is obtained.

Exemplary embodiments of the invention also pertain to a motor vehicle with a piston-cylinder arrangement. Vibrations occurring especially in motor vehicles can lead to chatter, i.e., to the knocking of the piston arrangement against the inside wall of the hollow cylinder, which can be advantageously avoided or at least reduced to a minimum by the radial damping element.

Additional tasks and many of the resulting advantages and exemplary embodiments of the present invention will be made more accessible and easier to understand by the following detailed description of exemplary embodiments and by reference to the associated drawing. Similar parts, parts which are essentially similar, and parts which are the same or serve the same function are designated by the same reference numbers:

### BRIEF DESCRIPTION OF THE DRAWINGS

FIG. 1 shows a longitudinal cross section through a piston-cylinder arrangement with a hollow cylinder and a piston arrangement with a radial damping element, the piston arrangement being installed in the cylinder;

FIG. 2 shows a cross section along lines A-A of FIG. 1 above the radial damping element;

FIG. 3 shows a longitudinal cross section through the radial damping element along lines B-B of FIG. 2;

FIG. 4 shows a longitudinal cross section through another piston-cylinder arrangement with a radial damping element, which has a projecting ring;

FIG. 5 shows a cross section along lines A-A of FIG. 4 above the radial damping element; and

FIG. 6 shows a longitudinal cross section through the radial damping element along lines B-B of FIG. 5.

### DETAILED DESCRIPTION OF THE PRESENTLY PREFERRED EMBODIMENTS

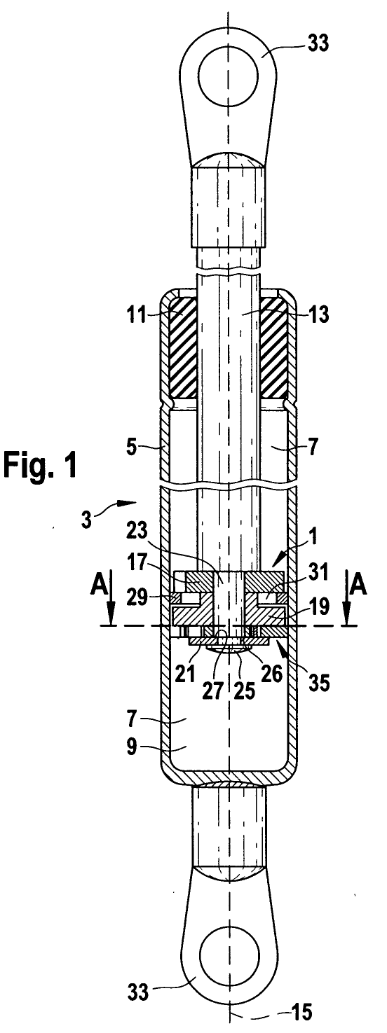

FIG. 1 shows a piston arrangement 1 as part of a piston-cylinder arrangement 3. The piston arrangement 1 divides the hollow cylinder 5 of the piston-cylinder arrangement 3 into two working spaces 7. The working spaces 7 of the hollow cylinder 5 are filled with a medium, in particular a gas 9. The gas 9 is under pressure and is enclosed within the hollow cylinder 5. For this purpose, the piston-cylinder arrangement 3 has a sealing and guide element 11 to seal off a piston rod 13, which projects through the interior of the hollow cylinder 5, from the outside. The piston rod 13 is mounted so that it can move axially back and forth relative to the hollow cylinder 5 along a center axis 15 of the piston arrangement 1 and of the piston-cylinder 3.

The piston arrangement 1 also has a star disk 17, a piston body 19, a piston disk 21, and a pin 23. The pin 23 is located at the end of the piston rod 13 and serves as a mount or centering element for the star disk 17, the piston body 19, and the piston disk 21. The pin 23 can be designed as a rivet pin with a head 25. The piston disk 21 is riveted to the pin 23 by way of the head 25, where the piston disk 21 thus rests against a shoulder 26 of the pin 23, which forms a stop; i.e., the disk is fixed in place between the shoulder 26 and the head 25 of the piston arrangement 1 by the riveting forces. The piston disk 21 therefore serves as a locking device, which holds the star disk 17 and the piston body 19 permanently in place on the pin 23.

The piston arrangement 1 also has a sealing ring 29, which is designed here with a square cross-section. The sealing ring 29 is positioned in the axial direction in the groove 31, formed between the star disk 17 and the piston body 19. The star disk 17, the piston body 19, and the sealing ring 29 form a throttle, valve, and/or switching device for the gas 9 flowing between the two working spaces 7 as a function of the direction of the axial movement of the piston arrangement 1 relative to the hollow cylinder 5.

As a result of the pressurized gas 9, a force is transmitted to the piston rod 15 of the piston-cylinder arrangement 3. To transmit this force to additional components such as components of a motor vehicle, such as to a hatch of a vehicle, the piston-cylinder arrangement 3 has two force-transmitting elements 33. The piston-cylinder arrangement 3, as shown in FIG. 1, therefore assumes the form of a gas spring.

The diameters of the star disk 17, of the piston body 19, and of the piston disk 21 are smaller than the diameter of the inside wall of the hollow cylinder 5 of the piston-cylinder arrangement 3. Therefore, these components are able to move relative to the hollow cylinder 5 to a greater or lesser extent in the lateral direction as a function of the guide forces applied by the sealing and guide element 11. For example, it is conceivable that elements of the piston arrangement 1 could strike the inside wall of the hollow cylinder 5 as a result of strong accelerations caused, for example, by a vibration of the components connected to the piston-cylinder arrangement or by lever forces acting on the piston rod 13 of the piston-cylinder arrangement 3. To prevent or at least to minimize such contact and thus to prevent or minimize the production of the undesirable noise associated with this contact, the piston arrangement 1 of the piston-cylinder 3 has a radial damping element 35. The radial damping element 35 is mounted on the pin 23 axially between the piston disk 21 and the piston body 19. The radial damping element 35 can also be located between other components of the piston arrangement 1. The radial damping element 35 is loaded in the radial direction against the inside wall of the hollow cylinder 5 and connected to the pin 23 of the piston arrangement 1.

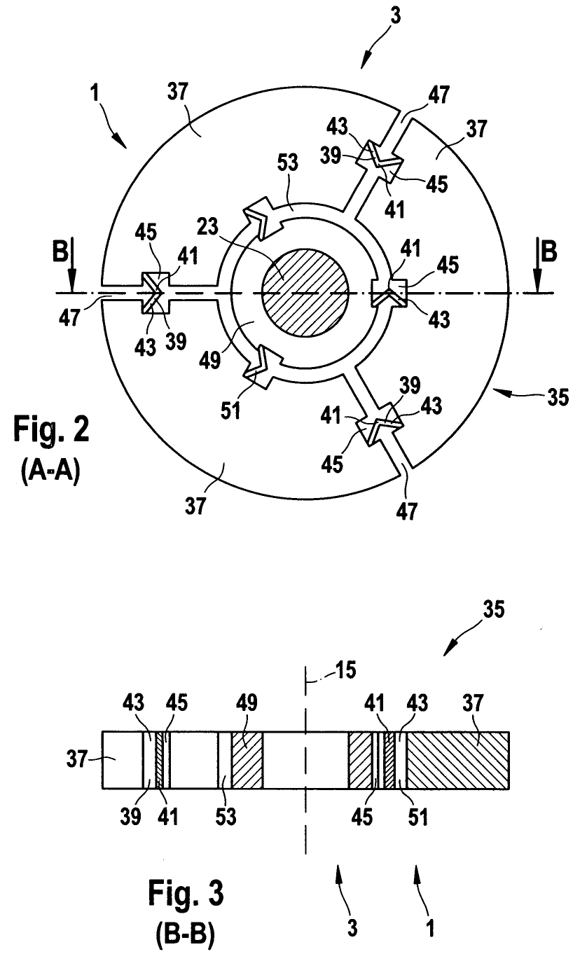

FIG. 2 shows a cross section along lines A-A of FIG. 1 above the radial damping element 35 without the hollow cylinder 5. What results is a plan view of the radial damping element 35.

The radial damping element 35 has three sections 37 in the shape of sectors of a circle. The sector-shaped sections 37 are identical and thus divide the periphery of the radial damping element 35 into three 1200 sectors. The radial damping element 35 can have more or fewer than three sector-shaped sections 37. It is also possible to provide sector-shaped sections 37 which are of different sizes from each other, that is, which extend around different angles.

The sector-shaped sections 37 are connected to each other elastically by means of spring damping elements 39. In particular, the spring damping elements 39 are fabricated out of the same piece material as the sector-shaped sections 37 and therefore form an integral connection. Materials such as elastic metals, plastics, elastomers, rubber, etc., are suitable. An additional piece of material with suitable elastic properties could also be used for the spring damping elements 39. Each of the spring damping elements 39 can form a material joint, in particular an elbow 41. For this purpose, each of the damping elements 39 is formed as an angled material strip, which connects two sector-shaped sections 37 elastically together. So that the spring damping elements 39 can be installed in the inward-bent (loaded) state, each of the sector-shaped sections 37 has two recesses 45. The recesses 45 of two adjacent sector-shaped sections 37 are arranged so that they are opposite each other.

FIG. 2 shows the radial damping element 35 in the relaxed state, where, between the sector-shaped sections 37, there is a gap 47, which defines the maximum amount of spring travel. The diameter of the radial damping element 35 in the relaxed state is larger than the inside diameter of the hollow cylinder 5 of the piston-cylinder arrangement 3. The spring damping elements 39 of the radial damping element 35 therefore must be bent inward to a certain extent so that the unit can be installed inside the hollow cylinder 5. As a result, the radially outward-directed loading of the sector-shaped sections 37 against the inside wall of the hollow cylinder 5 is obtained. To simplify installation, one edge or both edges of sections 37 can be beveled. Care must be taken to ensure that, even in the installed state, at least some of the gap 47 remains. The outside diameter of the radial damping element 35 and the inside diameter of the hollow cylinder 5 are for this purpose coordinated appropriately with respect to each other. The radial damping element 35 also has a ring 49, which is set down over the pin 23 of the piston arrangement 1. The pin 23 and the ring 49 of the radial damping element can have any desired type of fit, that is, either a fit with play or a press-fit, for example. The ring 49 is connected elastically to the three sector-shaped sections 37 of the radial damping element 35 by inner spring damping elements 51.

The inner spring damping elements 51 here have a design identical to that of the spring damping elements 39; that is, they also have a material joint 41 with a strip 43, which is introduced into a recess 45. The inner spring damping elements 51 can transmit radial forces between the outwardly pretensioned sector-shaped sections 37 and the ring 49. The ring 49, which is permanently connected to the piston arrangement 1 by the pin 23, therefore allows the piston arrangement 1 to move with elastic freedom with respect to the sector-shaped sections 37. Depending on the design of the spring damping elements 51, a more-or-less pronounced damping can occur in addition. An additional damping function can be achieved through the friction between the sector-shaped sections 37 and the piston disk 21 and the piston body 19. Because the sector-shaped sections 37 are supported against the inside wall of the hollow cylinder 5 and are spring-loaded against it, the way in which the ring 49 is supported with a damping and/or an elastic effect is enough to provide the piston arrangement 1 with damped and/or elastic support relative to the hollow cylinder 5 of the piston-cylinder arrangement 3.

FIG. 3 shows a longitudinal cross section through the radial damping element 35 along line B-B of FIG. 2. For the sake of simplicity, the diagram in FIG. 3 does not show the pin 23 of the piston arrangement 1. It is possible to see the ring 49, which is connected elastically by the inner spring damping element 51—visible in FIG. 3—to the sector-shaped section 37, shown in cross section, of the piston arrangement 1. It is also possible to see the material joint 41 of the visible inner spring damping element 51, which is formed by the strip 43. On the left of the ring 49, as seen in FIG. 3, is the circumferential gap 53, which remains between the ring 49 and the sector-shaped sections 37 of the radial damping element 35. Further to the left is one of the recesses 45, which is designed to accommodate the spring damping element 39, shown in cross section.

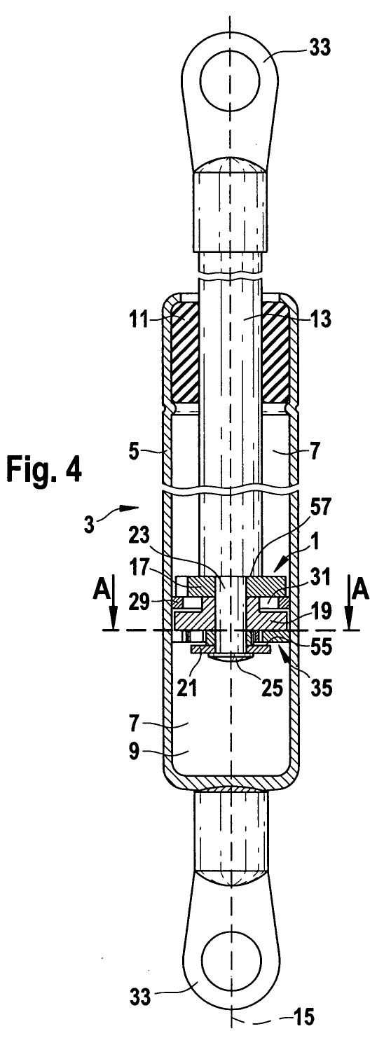

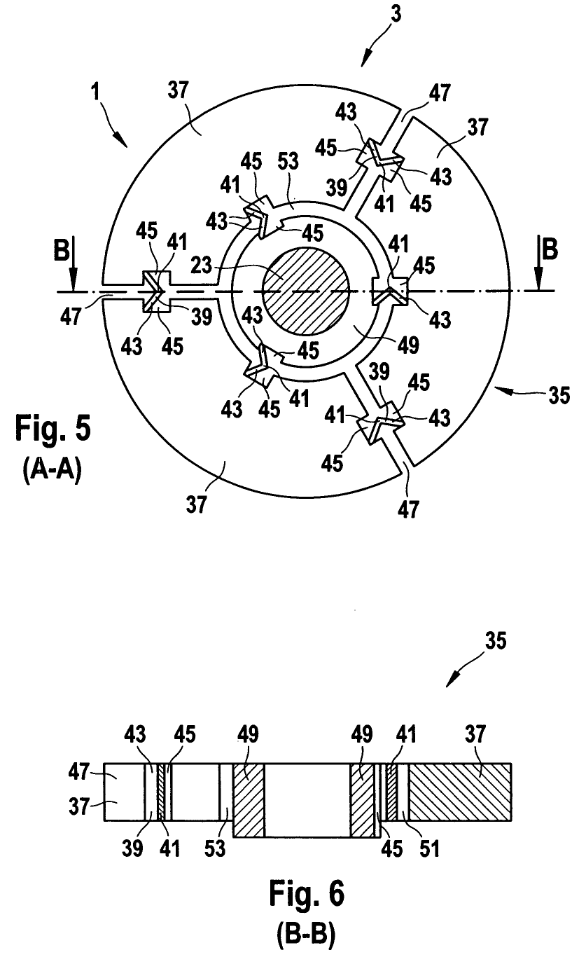

FIG. 4 shows a longitudinal cross section through another piston-cylinder arrangement 3 with a radial damping element 35, which has a projecting ring 49. FIG. 5 shows a cross section along lines A-A of FIG. 4 above the radial damping element 35. FIG. 6 shows a longitudinal cross section through the radial damping element 35 along lines B-B of FIG. 5. In the following, the differences with respect to the piston-cylinder arrangement illustrated in FIGS. 1-3 will be explained. The ring 49 of the radial damping element 35 shown in FIGS. 4-6 is thicker than the sector-shaped sections 37. As a result, as can be seen in FIG. 4, a free space 55 is present between the piston disk 21 and the sector-shaped sections 37. In addition, the piston disk 21, the thicker ring 49, the piston body 19, and the star disk 17 can now be clamped or riveted between the rivet head 25 of the pin 23 and one end 57 of the piston rod 13 without interfering with the free radial mobility of the sector-shaped sections 37. FIG. 6 shows the projection of the ring 49 resulting from its greater thickness—in the downward direction of FIG. 6. It is conceivable, alternatively or in addition, to provide the ring 49 with a projection beyond the sector-shaped sections 37 in the upward direction of FIG. 6.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A piston arrangement which can be fitted into a cylinder having an inside wall, the arrangement comprising:
a piston comprising a piston body; and
a radial damping element comprising at least two sector-shaped sections which are loaded radially outward for frictional contact with the inside wall of the cylinder.

2. The piston arrangement of claim 1 wherein the radial damping element further comprises spring damping elements located between the sector-shaped sections and loading the sections radially outward.

3. The piston arrangement of claim 2 wherein the spring damping elements are integrally connected to the sector-shaped sections.

4. The piston arrangement 3 wherein the spring damping elements are each formed as a material strip having an elbow.

5. The piston arrangement of claim 2 wherein the radial damping element comprises three of said sector-shaped sections and three of said spring damping elements.

6. The piston arrangement of claim 5 wherein the sector-shaped sections are connected to each other in pairs by the spring damping elements.

7. The piston arrangement of claim 2 wherein said sector-shaped sections having mutually facing recesses which receive said spring damping elements.

8. The piston arrangement of claim 1 further comprising a piston disk, said radial damping element being located axially between said piston body and said piston disk.

9. The piston arrangement of claim 8 further comprising a piston rod having an axially extending pin which supports said radial damping element.

10. The piston arrangement of claim 9 wherein the pin has a shoulder, the piston disk resting against the shoulder.

11. The piston arrangement of claim 1 wherein the radial damping element further comprises a ring, said sector-shaped sections surrounding said ring.

12. The piston arrangement of claim 11 further comprising inner spring damping elements located between the sector-shaped sections and the ring.

13. The piston arrangement of claim 12 wherein the inner spring damping elements are integrally connected to the sector-shaped sections and the ring.

14. The piston arrangement of claim 11 further comprising a piston rod having an axially extending pin which supports said radial damping element, said ring being located radially between said sector-shaped sections and said pin.

15. The piston arrangement of claim 14 wherein the ring and the sector-shaped sections each have an axial dimension, wherein the axial dimension of the ring is greater than the axial dimensions of the sector-shaped sections.

16. The piston arrangement of claim 1 wherein a gap is present between adjacent sector-shaped sections.

17. The piston arrangement of claim 1 wherein the sector-shaped sections can move relative to each other.

18. A piston cylinder arrangement comprising:
a cylinder having an inside wall; and
a piston arrangement received in the cylinder and dividing it into two working spaces, the piston arrangement comprising a piston and a radial damping element, the radial damping element comprising at least two sector-shaped sections which are loaded radially outward against the inside wall of the cylinder.

19. The piston-cylinder arrangement of claim 18 wherein the working spaces are filled with a gas.
